(19) United States
(12) Patent Application Publication
(10) Pub. No.: US 2010/0025980 A1
(43) Pub. Date: Feb. 4, 2010

(54) SECURITY PAPER INCLUDING DYED SECURITY FIBERS HAVING WAVELENGTH-DEPENDENT COLOR CHANGES AND METHOD OF MANUFACTURING THE SAME

(76) Inventors: Deok Kyu Choi, Daejeon (KR); Chung Ha Kil, Daejeon (KR); Yoon Jin Jang, Daejeon (KR)

Correspondence Address: ABELMAN, FRAYNE & SCHWAB, 666 THIRD AVENUE, 10TH FLOOR, NEW YORK, NY, 10017, US

(21) Appl. No.: 12/408,859

(22) Filed: Mar. 23, 2009

(30) Foreign Application Priority Data
Jul. 31, 2008 (KR) 10-2008-0075137

(51) Int. Cl. B42D 15/00; D21H 21/40

(52) U.S. Cl. 283/92; 162/140

(57) ABSTRACT

Disclosed is security paper including a plurality of dyed security fibers having wavelength-dependent color changes embedded therein, in which each of the plurality of dyed security fibers is composed of fluorescent balls formed of a fluorescent substance producing a light-mission response at a predetermined wavelength, a security fiber containing the fluorescent balls, and a dyed layer formed on the outer surface of the security fiber using a material producing an light-mission response at a predetermined wavelength.

### CROSS REFERENCE TO RELATED APPLICATION

This application claims the benefit of Korean Patent Application No. 10-2008-0075137, filed Jul. 31, 2008, entitled “Used making method for security paper and inherence security paper to color change security color string for according to speciality wavelength”, which is hereby incorporated by reference in its entirety into this application.

### BACKGROUND OF THE INVENTION

1. Field of the Invention

The present invention relates to security paper including dyed security fibers having wavelength-dependent color changes, and more particularly to security paper including a plurality of dyed security fibers embedded therein, in which each of the plurality of dyed security fibers is composed of fluorescent balls formed of a fluorescent substance producing a light-emission response at a predetermined wavelength, a security fiber containing the fluorescent balls, and a dyed layer formed on the outer surface of the security fiber using a material producing a light-emission response at a predetermined wavelength.

2. Description of the Related Art

Security fibers for security paper including stocks such as bank notes, checks or merchandise coupons, passports, certificates and so on are mainly manufactured by coating or dyeing typically spun synthetic resin fibers with a general dye, a fluorescent dye, an invisible fluorescent dye or a visible fluorescent dye. Such techniques are disclosed in U.S. Pat. No. 4,655,788, U.S. Pat. No. 4,921,280 and WO9945200A1. However, in the case where the security fibers thus manufactured are mixed with paper materials upon paper making, adhesive force or durability of the dye or pigment is undesirably reduced attributable to the wings of a stirrer, mechanical impact or contact with a chemical. In addition, U.S. Pat. No. 7,122,248B2 and KR10-0574411 as improvements over the above techniques disclose the addition of a fluorescent dye such as an inorganic phosphor to a process of spinning synthetic resin. However, the case where the inorganic phosphor is added to the process of spinning synthetic resin according to these techniques may cause problems. Specifically, when the particle size of the fluorescent substance is larger than 10 μm, yarn breakage may occur or a spinneret may be subjected to high pressure or may be blocked, undesirably stopping the spinning process. In particular, when secondary particles resulting from aggregation of particles having a particle size relatively larger or smaller than the average particle size of the inorganic phosphor are formed in a large amount, problems may also occur.

Moreover, the case where hardness of the fluorescent substance is high accelerates the wear of a discharge port or a spinner and thus affects subsequent processes including a drawing process, a cutting process and so on, as well as the spinning process. Accordingly, expensive devices should be used, disadvantageously negating economic benefits and adversely affecting productivity.

### SUMMARY OF THE INVENTION

Therefore, the present invention has been made keeping in mind the problems encountered in the related art and provides security paper, which is able to improve security performance through combining security elements, without generating structural or processing problems due to the addition of fluorescent dyes.

Also, the present invention provides a method of manufacturing the security paper.

An aspect of the present invention provides security paper including a plurality of dyed security fibers having wavelength-dependent color changes embedded therein, each of the plurality of dyed security fibers including fluorescent balls formed of a first fluorescent substance, a security fiber containing the fluorescent balls therein, and a dyed layer formed on an outer surface of the security fiber and having a second fluorescent substance.

Another aspect of the present invention provides a method of manufacturing security paper including dyed security fibers embedded therein, including mixing a synthetic resin for a security fiber with fluorescent balls formed of a first fluorescent substance, thus preparing a mixture (S10), spinning the mixture, thus obtaining a security fiber containing the fluorescent balls therein (S20), cutting the security fiber to a predetermined length, thus forming a plurality of cut security fibers (S30), dyeing an entire outer surface of the plurality of cut security fibers with a second fluorescent substances thus obtaining dyed security fibers (S40) and adding the dyed security fibers to a paper-making solution, thus manufacturing the security paper (S60).

### BRIEF DESCRIPTION OF THE DRAWINGS

FIG. 1 is a transverse sectional view showing dyed security fibers having wavelength-dependent color changes used in the security paper, according to the present invention;

FIG. 2 is a longitudinal sectional view showing dyed security fibers having wavelength-dependent color changes used in the security paper, according to the present invention;

FIG. 3 shows the security paper including dyed security fibers having wavelength-dependent color changes, according to the present invention; and

FIG. 4 is a flowchart showing a process of manufacturing the security paper including dyed security fibers having wavelength-dependent color changes, according to the present invention.

### DESCRIPTION OF THE PREFERRED EMBODIMENTS

Hereinafter, a detailed description will be given of the embodiments of the present invention, with reference to the accompanying drawings.

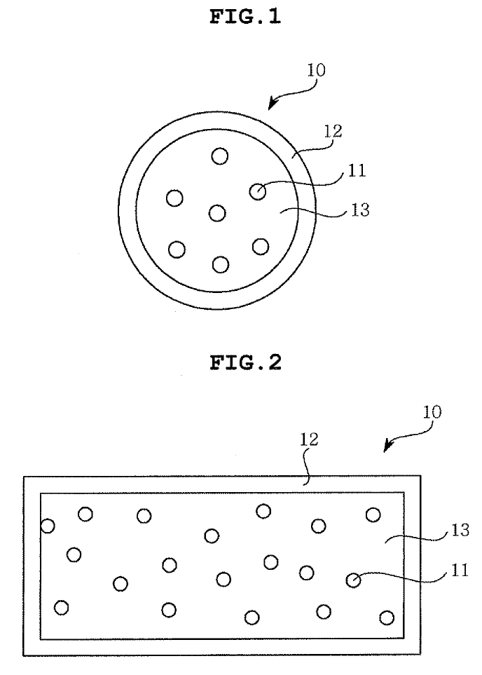

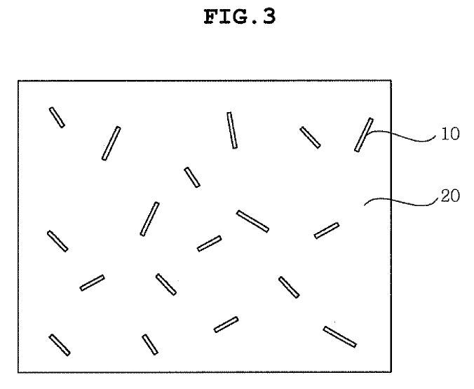

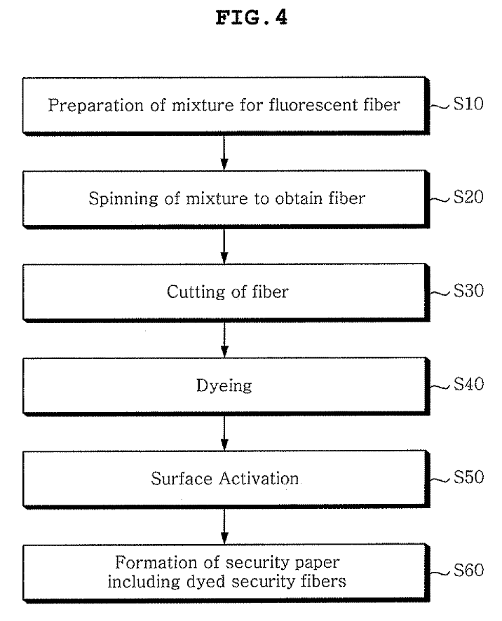

FIG. 1 is a transverse sectional view showing dyed security fibers having wavelength-dependent color changes which is used in the security paper according to the present invention, FIG. 2 is a longitudinal sectional view showing dyed security fibers having wavelength-dependent color changes which is used in the security paper according to the present invention, FIG. 3 shows the security paper including dyed security fibers having wavelength-dependent color changes according to the present invention, and FIG. 4 is a flowchart showing a process of manufacturing the security paper including dyed security fibers having wavelength-dependent color changes according to the present invention.

According to the present invention, the security paper 20 includes a plurality of dyed security fibers 10 embedded therein, in which each of the plurality of dyed security fibers 10 is composed of fluorescent balls 11 having a fluorescent substance producing a light-emission response at a predetermined wavelength, a security fiber 13 containing the fluorescent balls 11 therein, and a dyed layer 12 formed on the outer surface of the security fiber 13 using a material producing a light-emission response at a predetermined wavelength.

The fluorescent balls 11 are formed of a first fluorescent substance, and the dyed layer 12 is comprised of a second fluorescent substance.

The fluorescent balls 11 are excited and emit light at any one wavelength selected from among visible wavelengths, IR wavelengths and UV wavelengths.

The dyed layer 12 is excited and emits light at any one wavelength selected from among visible wavelengths, IR wavelengths and UV wavelengths.

Specifically, because the first and second fluorescent substance, which are respectively used for the fluorescent balls 11 and the dyed layer 12, have different wavelengths from each other, they do not exhibit the light-emission response at the same time but are respectively excited and emit light at different wavelengths selected from among visible wavelengths, IR wavelengths and UV wavelengths. The security paper according to the present invention includes the dyed security fibers having wavelength-dependent color changes.

The fluorescent balls 11 formed of the first fluorescent substance are contained in an amount of 1˜20 wt % in the security fiber 13. If the amount thereof is less than 1 wt %, a long period of time and high cost are required to confirm low fluorescence. In contrast, if the amount thereof exceeds 20 wt %, the particles may be aggregated, thus obtaining a non-uniform outer appearance, and also, it is not easy to handle such balls.

As the first fluorescent substance, any material may be used as long it surely has resistance to heat of a process of spinning the security fiber which will be mentioned below, and examples thereof include Honeywell Lumilux® CD164, CD117, CD135, Green UC-2, PTIR475/F, PTIR545,550/F, PTIR660/F and PTIR980/N available from PHOSPHOR TECHNOLOGY, and UPC-300 available from UK SEONG CHEMICAL. Also, as the second fluorescent substance for the dyed layer 12, any material may be used as long as dyeing is possible, and examples thereof include Honeywell Lumilux® CD306, CD326, CD729, PANAK 245 available from UK SEONG CHEMICAL, Ciba UVITEX OB, and Acid navy Blue and Acid Rec 3BN available from INOUE CHEMICAL.

The dyed security fibers 10 having the dyed layer 12 may have a fineness of 5˜50 deniers. If the fineness exceeds 50 deniers, the security fiber 13 may have a diameter of about 80 μm and thus may be detached from the paper. In contrast if the fineness is less than 5 deniers, the security fiber 13 may have a diameter of about 25 μm, which is too thin, thus requiring excessive effort to confirm a security element.

In addition, the present invention provides the method of manufacturing the security paper including dyed security fibers having wavelength-dependent color changes, including mixing a synthetic resin which is a main material of the security fiber 13 with the fluorescent balls 11 formed of the first fluorescent substance (S10), spinning the mixture thus preparing the security fiber 13 containing the fluorescent balls 11 therein (S20), cutting the security fiber 13 to a predetermined length thus forming a plurality of cut security fibers 13 (S30), dyeing the entire outer surface of the cut security fibers 13 with the second fluorescent substance thus forming the dyed security fibers 10 (S40), and adding the dyed security fibers to a paper-making solution during paper making thus manufacturing the security paper 20 (S60). In the manufacturing of the security paper, adding a surfactant so that the dyed security fibers are more uniformly dispersed in the paper-making solution, namely, a solution of pulp and other additives during the paper making thus activating the surface of the paper (S50) may be further included.

As mentioned above, the security fiber 13 contains 1˜20 wt % of the fluorescent balls having the first fluorescent substance and 80˜99 wt % of a polymer material. The polymer material used for the security fiber 13 is one or more selected from among polyester such as polyethyleneterephthalate and polybutyleneterephthalate, acryl, polyamide, polyvinylalcohol, acetate, polypropylene, polyolefin, polycarbonate and cellulose, and is processed into chips, which are then melt spun. To remove moisture from the mixture, a drying process may be performed before the spinning process. The temperature and time for the drying process may be controlled using a process known in the art depending on the kind of synthetic resin and the manufacturing conditions. The drying process is performed at about 100˜180° C. for about 6˜10 hours. If the drying process is performed at a temperature lower than about 100° C. or for a period of time shorter than about 6 hours, complete drying is not achieved, and thus breakage may occur in the spinning process. In contrast, if the drying process is performed at a temperature higher than about 180° C. or for a period of time longer than about 10 hours, part of the synthetic resin may be melted, and thus a large lump may be formed and energy may be wasted as a result.

In S30, the security fiber 13 is cut to a length of 8 mm or shorter. If the length of the fiber exceeds 8 mm, the cut security fibers may be excessively discharged in a screening process for removing impurities upon paper making, undesirably lowering paper-making efficiency.

The fluorescent balls 11 have a size of 10 μm or less.

The dyed layer is formed by dyeing the entire outer surface of the cut security fibers 13 with the fluorescent substance, and the dyeing process may be performed to be adapted for resin properties using a known technique.

Further, coating using a non-ionic surfactant may be performed, so that a larger amount of the cut security fibers 13 are more uniformly dispersed and combined with cellulose fibers in the course of paper making, thereby manufacturing the security paper 20 including the dyed security fibers 10 having the dyed layer 12.

As described hereinbefore, the present invention provides security paper including dyed security fibers having wavelength-dependent color changes and a method of manufacturing the same. According to the present invention, fluorescent substances which are excited and emit light at different specific wavelengths are used, and thus, fluorescent balls and a dyed layer having such substances can exhibit fluorescence including absorption or emission of solar light UV light or IR light. Even when the security fibers containing fluorescent substance are added in the course of paper making, the same fluorescence can be manifested, thereby preventing counterfeiting and enhancing security effects.

Further, when a surfactant is used, a larger amount of security fibers are combined with pulp in a paper-making process, thus increasing the embedding yield of the security fibers.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A security paper comprising a plurality of dyed security fibers having wavelength-dependent color changes embedded therein, each of the plurality of dyed security fibers comprising:
fluorescent balls formed of a first fluorescent substance;
a security fiber containing the fluorescent balls therein; and
a dyed layer formed on an outer surface of the security fiber and having a second fluorescent substance.

2. The security paper as set forth in claim 1, wherein the first fluorescent substance is an infrared fluorescent material, and the second fluorescent substance is an ultraviolet fluorescent material.

3. The security paper as set forth in claim 1, wherein the fluorescent balls are excited and emit light at any one wavelength selected from among visible wavelengths, infrared wavelengths and ultraviolet wavelengths.

4. The security paper as set forth in claim 1, wherein the dyed layer is excited and emits light at any one wavelength selected from among visible wavelengths, infrared wavelengths and ultraviolet wavelengths.

5. The security paper as set forth in claim 1, wherein the security fiber contains 1˜20 wt % of the fluorescent balls.

6. The security paper as set forth in claim 1, wherein each of the plurality of dyed security fibers having the dyed layer has a fineness of 5˜50 deniers.

7. A method of manufacturing security paper including dyed security fibers embedded therein, comprising:
mixing a synthetic resin for a security fiber with fluorescent balls formed of a first fluorescent substance, thus preparing a mixture;
spinning the mixture, thus obtaining a security fiber containing the fluorescent balls therein;
cutting the security fiber to a predetermined length, thus forming a plurality of cut security fibers;
dyeing an entire outer surface of the plurality of cut security fibers with a second fluorescent substance, thus obtaining dyed security fibers; and
adding the dyed security fibers to a paper-making solution, thus manufacturing the security paper.
